(19) United States
(12) Patent Application Publication
(10) Pub. No.: US 2015/0100979 A1
(43) Pub. Date: Apr. 9, 2015

(54) SYSTEM AND METHOD FOR CREATING CONTEXTUAL MESSAGES FOR VIDEOS

(71) Applicant: SMRTV, INC., Emeryville, CA (US)

(72) Inventors: Alan Moskowitz, Emeryville, CA (US); Randall Cook, Emeryville, CA (US); Kurt Dahlstrom, Emeryville, CA (US)

(73) Assignee: SMRTV, INC., Emeryville, CA (US)

(21) Appl. No.: 14/047,962

(22) Filed: Oct. 7, 2013

(51) Int. Cl. H04N 21/234; H04N 21/81

(52) U.S. Cl. CPC H04N 21/23424; H04N 21/812
USPC 725/32

(57) ABSTRACT

Described herein are techniques for creating contextual messages for videos. In one example, there is provided a method operable by a network entity, involving receiving a request to create a video clip of a media broadcast. The network entity may identify a video segment of the media broadcast then determines a context identifier for the video segment. The network entity may create a contextual message to accompany the video segment based on the context identifier and may provide the contextual message along with the video segment to a clip viewer.

### BACKGROUND

The present disclosure relates to broadcast content processing and delivery, and more particularly to contextual messages for videos.

People are increasingly sharing their TV viewing experience with their friends, family, and the public using online social networks and online video services. For example, a basketball fan might viewing a game may share a ten second video clip of a game-changing play on an online social networking.

Traditionally, advertising related to broadcast television (TV) involved of inserting commercials into and between TV programs. Then the advent of the internet and the popularity of online videos in particular have brought new advertising opportunities. Advertisements are now also inserted into millions of online videos.

Advertisements aim to provide goods or services to potential customers, thus advertisers aim to select advertisements pertinent to viewers. However, most advertisements are currently selected at random in relation to the online videos they are inserted into. In the example involving the basketball fan, the shared video clip of the game-changing play may include an unrelated advertisement for flowers. There is a need for an efficient automatic method of choosing advertisements related to a context of the online video.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects of the aspects described herein, there is provided a method for creating contextual messages for videos. In one implementation, a network entity may identify a video segment of a media broadcast based on at least one of a channel identification, a clip start time, and a clip end time. The network entity may determine a context identifier for the video segment based on at least one of the channel identification, the clip start time, or the clip end time. The network entity may create a contextual message to accompany the video segment based at least in part on the context identifier.

To the accomplishment of the foregoing and related ends, the one or more aspects include the features hereinafter fully described and particularly pointed out in the claims. The following description and the annexed drawings set forth in detail certain illustrative aspects of the one or more aspects. These aspects are indicative, however, of but a few of the various ways in which the principles of various aspects may be employed and the described aspects are intended to include all such aspects and their equivalents.

### BRIEF DESCRIPTION OF THE DRAWINGS

FIG. 1 is a block diagram illustrating an example of a system for creating contextual messages for videos;

FIG. 2 illustrates a flowchart for creating contextual messages for videos;

FIG. 3A illustrates an example methodology for creating contextual messages for videos;

FIG. 3B shows further aspects of the methodology of FIG. 3A;

FIG. 4A illustrates an aspect of an apparatus for creating contextual messages for videos; and

FIG. 4B shows further aspects of the apparatus of FIG. 4A.

### DETAILED DESCRIPTION

Various aspects are described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects. The word “exemplary” is used herein to mean “serving as an example, instance, or illustration.” Any aspect described herein as “exemplary” is not necessarily to be construed as preferred or advantageous over other aspects.

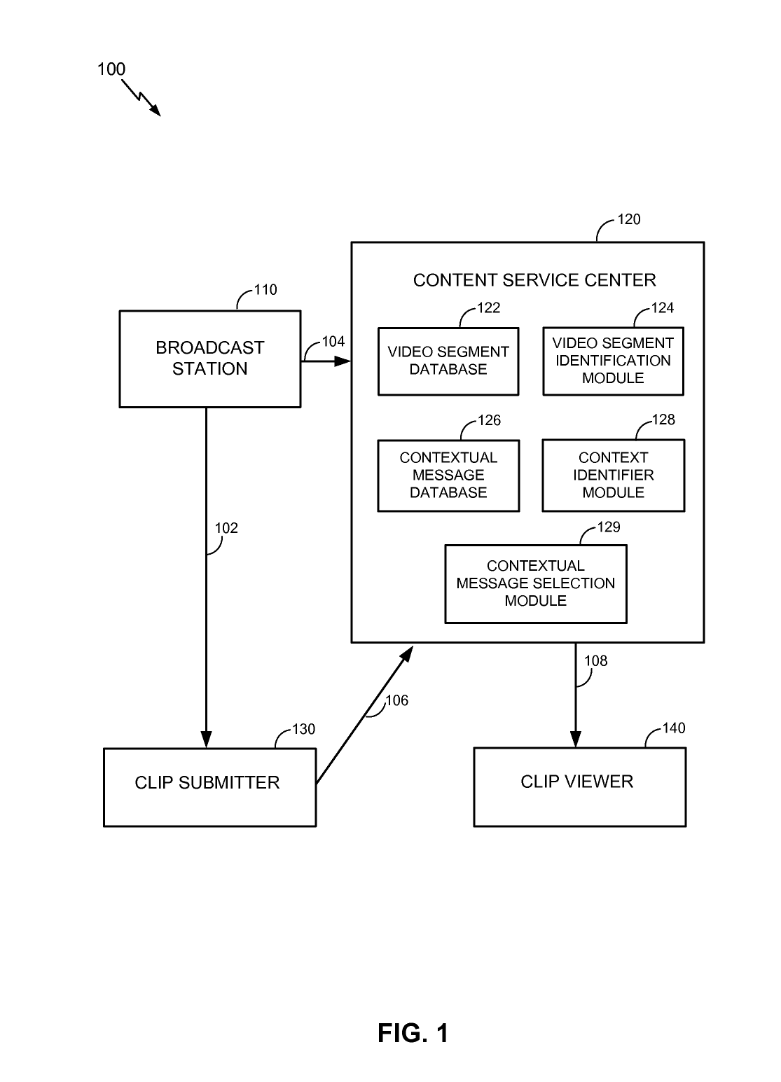

FIG. 1 shows an example system 100 in accordance with one or more aspects of the aspects described herein. A broadcast station 110, such as for example a television station, may broadcast media through cable or over the air to a great number of viewers. The media broadcast may include digital or analog data signals for audio and video content. The broadcast station 110 may be a TV station including a transmitter for broadcasting the media data. Although FIG. 1 illustrates one block to represent the broadcast station 110, it is understood that the broadcast station 110 may refer to more than one facility located in different geographic areas. It is further understood that one or more broadcast stations 110 may simultaneously transmit the media broadcast over a plurality of channels or frequencies. For example, a different television program may be transmitted on each of a plurality of television channels.

In an example aspect, the media broadcast may be at least one of a television broadcast, a radio broadcast, or an internet broadcast. The media broadcast may include audio in addition to video data. The media broadcast may be live or prerecorded. The transmission may be continuous or may start and stop over periods of time. The media broadcast may be in either analog or digital format. Example analog television systems, which are encoding or formatting standards, in current use are NTSC, PAL, and SECAM. In a related aspect, digital television systems may use the MPEG transport stream format or the like.

A clip submitter 130 may receive the media broadcast 102 from the broadcast station 110. For example, the clip submitter may be a person watching the media broadcast on at least one of a television, a mobile phone, a computer, a tablet, or the like. The clip submitter may choose to specify a video segment of the media broadcast 102. For example, the clip submitter 130 may find a particular video segment from the media broadcast 102 to be interesting and wishes to share it with friends. In an example aspect, the video segment may be specified by at least one of a channel identification, a clip start time, or a clip end time. To illustrate by example, a clip submitter watching the media broadcast on a TV may decide to share with friends on an online social network a ten second video segment of an action movie involving a sports car. The segment may be specified by the channel identification of “HBO”, and a clip start time of 7:30:45 pm, and a clip end time of 7:30:55 pm. In a related aspect, the clip start time and the clip end time may refer to an absolute time such as a time of day. In another related aspect, the clip start time and the clip end time may refer to a relative time in relation to an event.

In a related aspect, the clip submitter 130 may specify the channel identification, the clip start time, or the clip end time into a user device such as a mobile phone, a tablet, a computer, a TV set-top box, or the like. For example, the clip submitter 130 may use a keypad on the user device or give a voice command to the user device. In another example, the user device may automatically specify the channel identification, the clip start time, or the clip end time in response to a user command For example, the user device may automatically select a channel currently being displayed on the TV and select the clip start and clip end time corresponding to a duration of a predetermined number of seconds. The clip submitter may then edit the clip start or clip end time. In a related aspect, an application on the user device such as a mobile phone application may facilitate the specifying of the video segment.

The clip submitter 130 may send to a content service center 120 a request 106 to create a video clip of the media broadcast, the request 106 including at least one of the channel identification, the clip start time, or the clip end time. The application on the user device may facilitate the sending of the request. The content service center 120 may include a video segment identification module 124 that receives and processes the request to create a video clip from the clip submitter 130. The video segment identification module 124 may identify a video segment of the media broadcast based on the channel identification, the clip start time, and the clip end time.

The content service center 120 may receive the same media broadcast 104 also received by the clip submitter 130. A video data file corresponding to the identified video segment may be created using the media broadcast 104. The content service center 120 may include a video segment database 122 that stores the video data file for the identified video segment. In a related aspect, the video segment database 122 may store a large number of data files corresponding to different video segments. In the example of the video segment involving the sports car, the video segment database 122 may store a video data file for the ten second video clip.

The content service center 120 may include a context identifier module 128 that determines a context identifier for the identified video segment based on the channel identification, the clip start time, and the clip end time. In an example aspect, the context identifier module 128 may determine at least one of a product name, a name of a person, a location name, an activity name, a business name, or a service name, that is shown in, mentioned in, or related to subject matter of the video segment. In a related aspect, the determination of the context identifier may include performing at least one of optical image recognition, optical character recognition, audio recognition, voice recognition, broadcast program schedule recognition, or program metadata recognition for the identified video segment. In the example of the video segment involving the sports car, the context identifier module 128 may determine a make and model of the sports car as the context identifier.

The content service center 120 may include a contextual message database 126. The contextual message database 126 may include a variety of different contextual messages that may accompany a video clip. For example, contextual messages may include a still image or photo, an animated image or photo, a video clip, or a sound clip. The contextual messages may include advertisements, informational messages, or other media. The contextual message database 126 may include a large number of different contextual messages that relate to a variety of different subjects. For example, the contextual message database 126 may be an advertising database storing a plurality of advertisements. To illustrate by example, the advertising database may store videos and images for sports cars, clothing, jewelry, electronics, and home improvement services.

The content service center 120 may include a contextual message selection module 129. The contextual message selection module 129 may match the determined context identifier with a relevant contextual message. The contextual message may be selected from the variety of different contextual messages stored in the contextual message database 126, based at least in part on the contextual identifier. In a related aspect, the content service center 120 may select an advertisement as the contextual message from a plurality of advertisements stored on an advertising database by applying an algorithm that factors the context identifier. In a related aspect, the algorithm may select the contextual message based on a number of additional factors such as for example date and time, priority rules, advertising fees, target demographics, or individual target preferences. In the example of the video segment involving the sports car, the algorithm may select a five second video advertisement for the purchase of the particular make and model of the sports car in the video segment as the contextual message.

Although FIG. 1 illustrates one block to represent the content service center 120, it is understood that the content service center 120 may refer to more than one facility located in different geographic areas. Although various blocks are shown inside the content service center block, it is understood that each of the various blocks may be located in one or more separate facilities.

The content service center 120 may provide a clip viewer 140 the contextual message along with the identified video segment 108. Although FIG. 1 does not illustrate intermediary blocks between the content service center 120 and the clip viewer 140, it is understood that the contextual message along with the identified video segment 108 may be processed or stored at an intermediary location. For example, the intermediary location may be an online social network or a video sharing service. The clip viewer 140 may be one of a plurality of people to view the identified video segment. In an example aspect, the clip viewer 140 may use at least one of a television, a mobile phone, a computer, a tablet, or the like to view the identified video segment. The contextual message may be shown before, during, or after the video segment. For example, the contextual message may be a five second video advertisement that plays before the identified video segment. In another example, the contextual message may be an image displayed at the bottom area of the identified video segment. In the example of the video segment involving the sports car, friends of the clip submitter may view the video segment on the online social network and view the five second video advertisement for the purchase of the particular make and model of the sports car immediately after viewing the video segment.

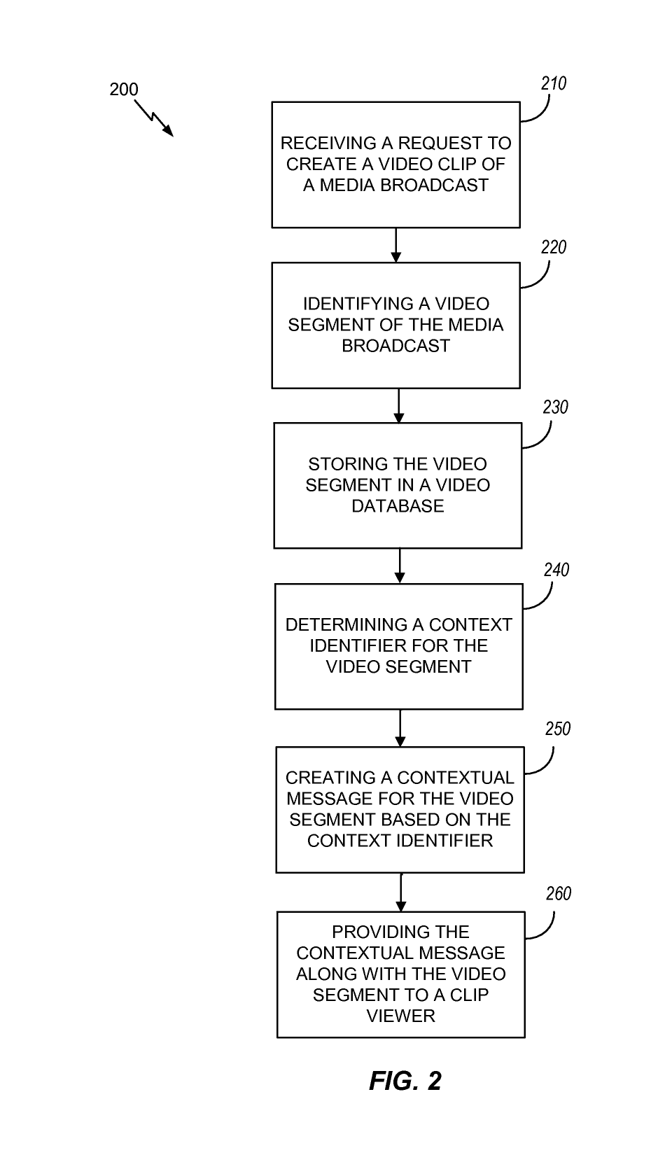

FIG. 2 illustrates a flowchart of a method 200 for creating contextual messages for videos, operable by a network device. At block 210, the network device may receive a request to create a video clip of a media broadcast. At block 220, the network device may identify a video segment of the media broadcast. At block 230, the network device may store the video segment in a video database. At block 240, the network device may determine a context identifier for the video segment. At block 250, the network device may create a contextual message for the video segment based on the context identifier. At block 260, the network device may provide the contextual message along with the video segment to a clip viewer.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

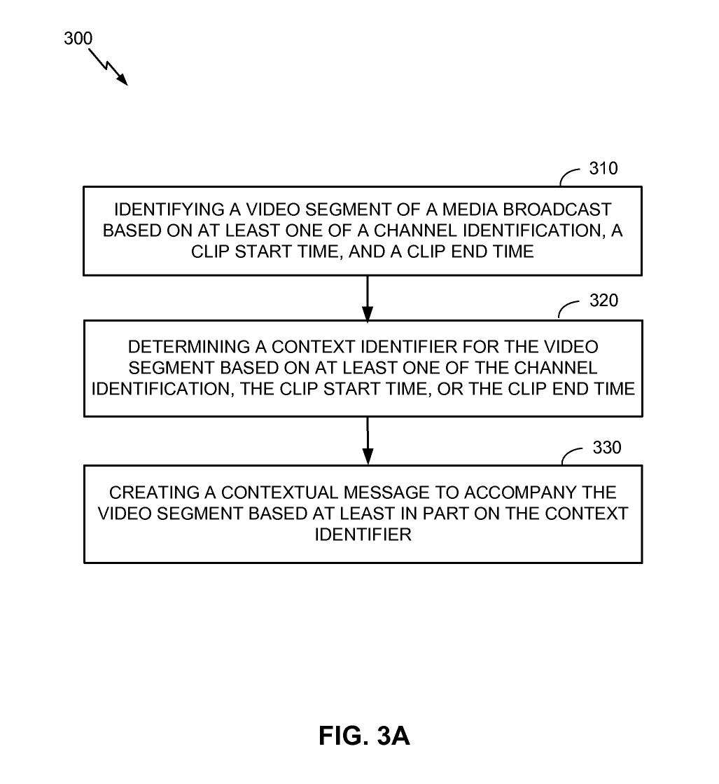

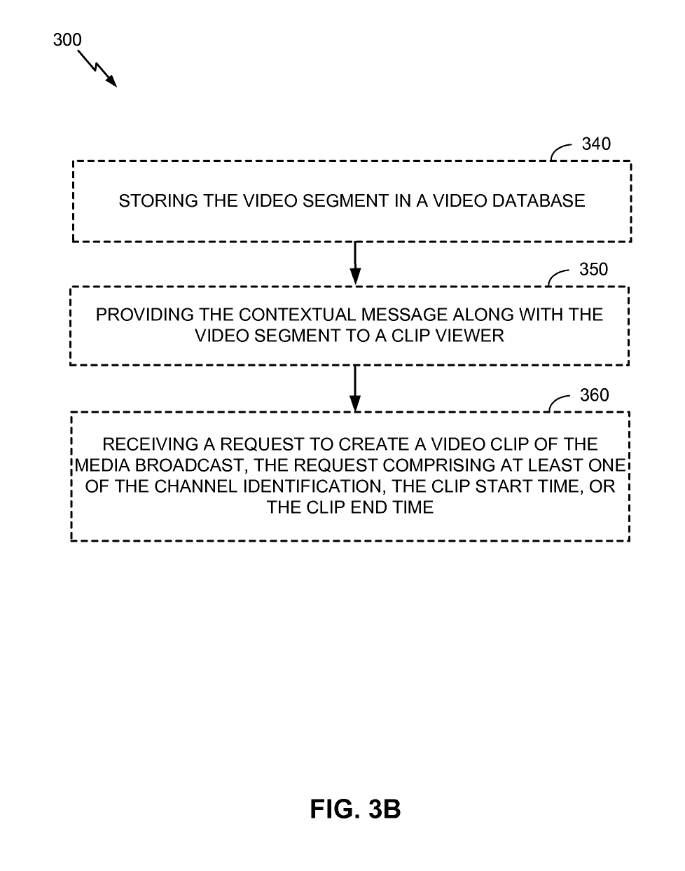

In accordance with one or more aspects of the aspects described herein, with reference to FIG. 3A, there is shown a methodology 300 for creating contextual messages for videos. The method 300, operable by the network entity or the like or component(s) thereof, may involve, at 310, identifying a video segment of a media broadcast based on at least one of a channel identification, a clip start time, and a clip end time. For example, identifying the video segment may include receiving at least one of the channel identification, the clip start time, or the clip end time from a clip submitter. In another example, identifying the video segment may include receiving the channel identification, the clip start time, and the clip end time from a mobile device application operated by the clip submitter. In a related aspect, the media broadcast may include at least one of a live television broadcast, a live radio broadcast, or a live internet broadcast.

The method 300 may involve, at 320, determining a context identifier for the video segment based on at least one of the channel identification, the clip start time, or the clip end time. In a related aspect, determining the context identifier may include determining at least one of a product name, a name of a person, a location name, an activity name, a business name, or a service name, that is shown in, mentioned in, or related to subject matter of the video segment. In another related aspect, determining the context identifier may include performing at least one of optical image recognition, optical character recognition, audio recognition, voice recognition, broadcast program schedule recognition, or program metadata recognition for the video segment.

The method 300 may involve, at 330, creating a contextual message to accompany the video segment based at least in part on the context identifier. In an exemplary aspect, creating the contextual message may include selecting an advertisement from a plurality of advertisements stored on an advertising database by applying an algorithm that factors the context identifier. In another exemplary aspect, creating the contextual message may occur in real-time.

FIG. 3B show further optional operations or aspects of the method 300 described above with reference to FIG. 3A. If the method 300 includes at least one block of FIGS. 3A, then the method 300 may terminate after the at least one block, without necessarily having to include any subsequent downstream block(s) that may be illustrated. It is further noted that numbers of the blocks do not imply a particular order in which the blocks may be performed according to the method 300.

The method 300 may involve, at 340, storing the video segment in a video database. The method 300 may further involve, at 350, providing the contextual message along with the video segment to a clip viewer. In a related aspect, providing the contextual message may include providing the contextual message before, during, or after the providing of the video segment to the clip viewer. In a further related aspect, providing the video segment may include providing at least one of the video segment or the contextual message to the clip viewer through an online social network.

The method 300 may involve, at 360, receiving a request to create a video clip of the media broadcast, the request comprising at least one of the channel identification, the clip start time, or the clip end time.

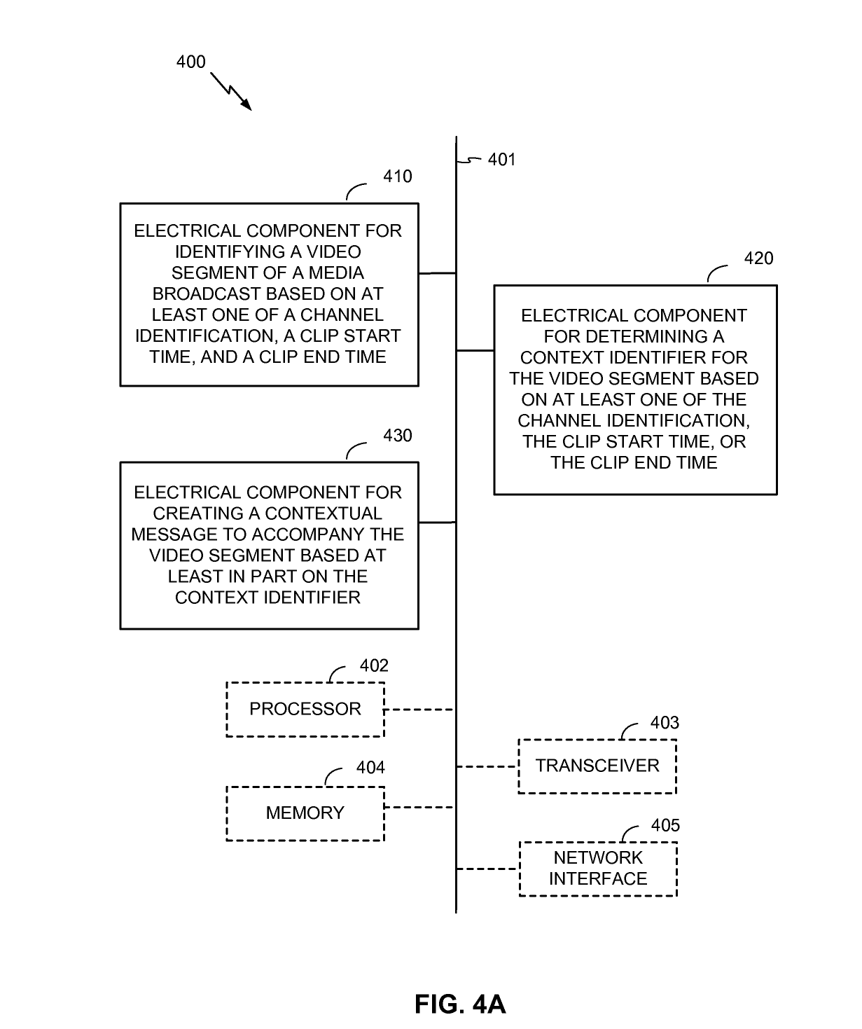

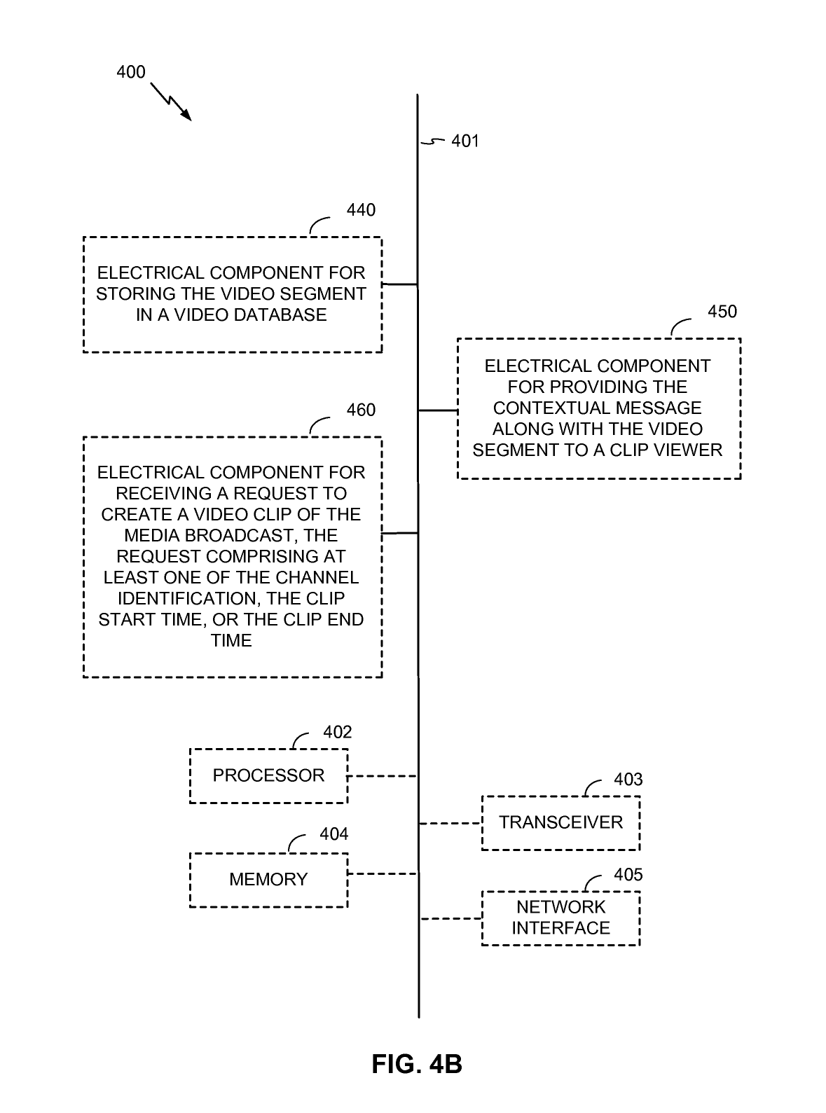

In accordance with one or more aspects of the aspects described herein, FIG. 4A shows a design of an apparatus 400 for automated broadcast media identification. The exemplary apparatus 400 may be configured as a computing device or as a processor or similar device/component for use within. In one example, the apparatus 400 may include functional blocks that can represent functions implemented by a processor, software, or combination thereof (e.g., firmware). In another example, the apparatus 400 may be a system on a chip (SoC) or similar integrated circuit (IC).

In one aspect, apparatus 400 may include an electrical component or module 410 for identifying a video segment of a media broadcast based on at least one of a channel identification, a clip start time, and a clip end time. For example, the video segment identification module 124 of the content service center 120 may receive the channel identification, the clip start time, and the clip end time from a clip submitter 130, as shown in FIG. 1.

The apparatus 400 may include an electrical component 420 for determining a context identifier for the video segment based on at least one of the channel identification, the clip start time, or the clip end time. For example, the context identifier module 128 of the content service center 120 may determine the context identifier for the video segment, as shown in FIG. 1.

The apparatus 400 may include an electrical component 430 for creating a contextual message to accompany the video segment based at least in part on the context identifier. For example, the contextual message selection module 129 may select a contextual message from the contextual message database 126, as shown in FIG. 1.

In related aspects, as described in FIG. 4B, the apparatus 400 may optionally include an electrical component 440 for storing the video segment in a video database. For example, the video segment database 122 of the content service center 120 may store the video segment, as shown in FIG. 1.

The apparatus 400 may optionally include an electrical component 450 for providing the contextual message along with the video segment to a clip viewer. For example, the content service center 120 may send the video segment and the contextual message to the clip viewer 140, as shown in FIG. 1.

The apparatus 400 may optionally include an electrical component 460 for receiving a request to create a video clip of the media broadcast, the request comprising at least one of the channel identification, the clip start time, or the clip end time. For example, the content service center 120 may receive the request from the clip submitter 130, as shown in FIG. 1.

In further related aspects, the apparatus 400 may optionally include a processor component 402. The processor 402 may be in operative communication with the components 410-460 via a bus 401 or similar communication coupling. The processor 402 may effect initiation and scheduling of the processes or functions performed by electrical components 410-460.

In yet further related aspects, the apparatus 400 may include a radio transceiver component 403. A standalone receiver and/or standalone transmitter may be used in lieu of or in conjunction with the transceiver 403. The apparatus 400 may also include a network interface 405 for connecting to one or more other communication devices or the like. The apparatus 400 may optionally include a component for storing information, such as, for example, a memory device/component 404. The computer readable medium or the memory component 404 may be operatively coupled to the other components of the apparatus 400 via the bus 401 or the like. The memory component 404 may be adapted to store computer readable instructions and data for effecting the processes and behavior of the components 410-460, and subcomponents thereof, or the processor 402, or the methods disclosed herein. The memory component 404 may retain instructions for executing functions associated with the components 410-460. While shown as being external to the memory 404, it is to be understood that the components 410-460 can exist within the memory 404. It is further noted that the components in FIGS. 4A and 4B may comprise processors, electronic devices, hardware devices, electronic sub-components, logical circuits, memories, software codes, firmware codes, etc., or any combination thereof

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm operations described in connection with the disclosure herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary designs, the functions described may be implemented in hardware, software, firmware, or any combination thereof If implemented in software, the functions may be stored on or transmitted over as one or more instructions or code on a non-transitory computer-readable medium. Non-transitory computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for real-time context comprehension, operable by a network entity, comprising:
identifying a video segment of a media broadcast based on at least one of a channel identification, a clip start time, and a clip end time;
determining a context identifier for the video segment based on at least one of the channel identification, the clip start time, or the clip end time; and
creating a contextual message to accompany the video segment based at least in part on the context identifier.

2. The method of claim 1, further comprising:
storing the video segment in a video database; and
providing the contextual message along with the video segment to a clip viewer.

3. The method of claim 2, wherein providing the contextual message comprises providing the contextual message before, during, or after the providing of the video segment to the clip viewer.

4. The method of claim 2, wherein providing the video segment comprises providing at least one of the video segment or the contextual message to the clip viewer through an online social network.

5. The method of claim 1, further comprising receiving a request to create a video clip of the media broadcast, the request comprising at least one of the channel identification, the clip start time, or the clip end time.

6. The method of claim 1, wherein identifying the video segment comprises receiving at least one of the channel identification, the clip start time, or the clip end time from a clip submitter.

7. The method of claim 6, wherein identifying the video segment comprises receiving the channel identification, the clip start time, and the clip end time from a mobile device application operated by the clip submitter.

8. The method of claim 1, wherein determining the context identifier comprises determining at least one of a product name, a name of a person, a location name, an activity name, a business name, or a service name, that is shown in, mentioned in, or related to subject matter of the video segment.

9. The method of claim 1, wherein the media broadcast comprises at least one of a television broadcast, a radio broadcast, or an internet broadcast.

10. The method of claim 1, wherein determining the context identifier comprises performing at least one of optical image recognition, optical character recognition, audio recognition, voice recognition, broadcast program schedule recognition, or program metadata recognition for the video segment.

11. The method of claim 1, wherein creating the contextual message comprises selecting an advertisement from a plurality of advertisements stored on an advertising database by applying an algorithm that factors the context identifier.

12. The method of claim 1, wherein creating the contextual message occurs in real-time.

13. A real-time context comprehension apparatus, comprising:
at least one processor configured to:
identify a video segment of a media broadcast based on at least one of a channel identification, a clip start time, and a clip end time;
determine a context identifier for the video segment based on at least one of the channel identification, the clip start time, or the clip end time; and
creating a contextual message to accompany the video segment based at least in part on the context identifier; and
a memory coupled to the at least one processor for storing data.

14. The apparatus of claim 13, wherein the at least one processor is further configured to:
store the video segment in a video database; and
provide the contextual message along with the video segment to a clip viewer.

15. The apparatus of claim 13, wherein the at least one processor is further configured to receive a request to create a video clip of the media broadcast, the request comprising at least one of the channel identification, the clip start time, or the clip end time.

16. The apparatus of claim 13, wherein the at least one processor is further configured to receive a request to create a video clip of the media broadcast, the request comprising at least one of the channel identification, the clip start time, or the clip end time.

17. An apparatus, comprising:
means for identifying a video segment of a media broadcast based on at least one of a channel identification, a clip start time, and a clip end time;
means for determining a context identifier for the video segment based on at least one of the channel identification, the clip start time, or the clip end time; and
means for creating a contextual message to accompany the video segment based at least in part on the context identifier.

18. The apparatus of claim 17, further comprising:
means for storing the video segment in a video database; and
means for providing the contextual message along with the video segment to a clip viewer.

19. The apparatus of claim 17, further comprising means for receiving a request to create a video clip of the media broadcast, the request comprising at least one of the channel identification, the clip start time, or the clip end time.

20. A computer program product, comprising:
a non-transitory computer-readable medium comprising code for causing a computer to:
identify a video segment of a media broadcast based on at least one of a channel identification, a clip start time, and a clip end time;
determine a context identifier for the video segment based on at least one of the channel identification, the clip start time, or the clip end time; and
create a contextual message to accompany the video segment based at least in part on the context identifier.

21. The computer program product of claim 20, wherein the non-transitory computer-readable medium further comprises code for causing the computer to:
store the video segment in a video database; and
provide the contextual message along with the video segment to a clip viewer.

22. The computer program product of claim 20, wherein the non-transitory computer-readable medium further comprises code for causing the computer to receive a request to create a video clip of the media broadcast, the request comprising at least one of the channel identification, the clip start time, or the clip end time.
